(19) United States
(12) Patent Application Publication
(10) Pub. No.: US 2008/0121107 A1
(43) Pub. Date: May 29, 2008

(54) Device for the passage of air with control unit

(76) Inventor: Andreas Pfannenberg, Hamburg (DE)

Correspondence Address: Friedrich Kueffner, Suite 910, 317 Madison Avenue, New York, NY, 10017, US

(21) Appl. No.: 11/895,634

(22) Filed: Aug. 24, 2007

(30) Foreign Application Priority Data
Oct. 12, 2006 (DE) 20 2006 015 789.1

(51) Int. Cl. B01D 46/42; B01D 50/00

(52) U.S. Cl. 96/417; 55/385.6; 55/385.1

(57) ABSTRACT

The invention relates to a device for the passage of air (200), in particular filter fan or output filter, with a blast (20) or without a blast, for fitting in a mounting opening (50) in a wall (51), in particular of a casing for waste heat producing components, such as a switch cupboard, an electronic cupboard, a computer system or the like, whereby the device for the passage of air (200) comprises a basic casing (21) with or without a blast support (25), a covering device (100) configured as a design cover (80) with or without peripheral side walls (30a, 30b, 30c, 30d) moulded on the air outlet side and which can be inserted into the basic casing (21) and with a covering device (100) configured with a fan grid (10) which has lamellar elements (90, 90′) held on the opposed side walls (30b, 30d) of the design cover (80) and a filter mat (60) placed between the basic casing (21) and the fan grid (10). The aim of this invention is to configure a device for the passage of air according to the above mentioned type in such a manner that it is possible to check the correct state of operation thereof without dismounting the fan or without checking the seat of the fan. This aim is achieved in that a control device is provided for with which the correct state of operation of the device for passage of air (200) can be ascertained, whereby the control device (300) contains at least one monitoring element (360) and at least a control element (330) for ascertaining the state of operation.

This invention relates to a device for the passage of air, in particular to a filter fan or outlet filter, according to the preamble of claim 1.

For components placed in a casing which produce waste heat, it is necessary to carry away the waste heat form the casing and to control a temperature in the casing by more or less strong blowing in or sucking off of ambient air into the casing inner space by means of a fan. Computer casings are a known example for this. Usually such casings are provided with a filter fan which either is continually running or which is switched on and off by a control device depending on a temperature in the casing. The filter fan is placed in a recess of a wall of the casing and fixed for example by means of screwed connections. Simultaneously corresponding air outlet slits are provided at another place of the casing for the air outlet.

Because of the electrostatic charging of the electronic structural members and components which are placed in the inside of the casing, dirt and dust particles accumulate thereon so that there can be dysfunctions of the components. In order to avoid dirt accumulation, it is known to provide in the fan an additional filter mat preferably of a knitted or needled synthetic material in order to filter out these dust and dirt particles from the air which is conveyed through the fan in a flow direction. For this purpose, a filter mat is preferably placed in flow direction of the air before the blast of the fan, whereby an intermediate space between the filter mat and the blast is closed substantially air tight against the ambient air by a basic casing and a blast support. The filter mats used for these filter fans are placed between the outer filter grid and the basic casing. The fan grid is removably connected with the basic casing by means of clamping or snap-in connections or screwed connections.

It is aimed at that it is easily possible for the user of heat producing components to check if the operation takes place according to the wished parameters. This being, the air throughput must be guaranteed. However it must also be simultaneously guaranteed that the filter effect complies with the wished requirements. This does not always exist when the filter is soiled or when the fan grid is not correctly closed and when thus unfiltered air can pass through.

The aim of this invention is to configure a device for the passage of air according to the type described above so that it is possible to check the correct state of operation thereof without dismounting the filter or checking the seat of the fan.

The aim of a device for the passage of air is achieved with the characteristics indicated in claim 1.

By providing the control device, it is possible in a simple manner to check quickly and efficiently if the state of operation of the device for the passage of air is within the wished parameters or outside thereof. This being, the monitoring element makes available the necessary data to the control unit in which the mode of operation or the deviation therefrom is ascertained.

Advantageous configurations of the invention are the subject of the subclaims.

It can be easily ascertained by contact switches, in particular by microswitches, if the device for the passage of air is duly closed. It can also be easily ascertained by them if a filter is inserted in the device at all.

For example, a teaching of the invention provides that it is possible for measuring air pressures to use piezocrystals which emit pressure dependent electric signals which are again evaluated in the preferably electronically working control unit and which are indicated to the user for example by means of a display element. But the air pressure can also take place mechanically and the pressure difference be indicated with mechanical indicating devices.

It is obvious that with increasing contamination the pressure difference continuously increases before and behind the filter mat, this being seen in flow direction, whereby a maximal admissible contamination of the filter man can be assigned to a limit value of a pressure difference. This means that for this degree of contamination only an air quantity can still be conveyed by the blast of the fan through the air mat which is so slight that a sufficient ventilation or cooling of the electronic components placed in the casing for example of the computer system is guaranteed and that their damage cannot be excluded. As soon as such a contamination of the filter mat is achieved, it must be replaced for a troublefree operation of the fan or of the thus ventilated computer system. The achieving of this contamination or of the thus increasing pressure drop is communicated to the user by appropriate indicating devices.

With the indication that the filter mat of the fan must be replaced, an unnecessary checking of the contamination of the filter mat which is eventually related to expensive dismounting work of the fan and in particular with stop times, for example of the computer system, is avoided so that the operating costs of the whole system are reduced. The fan can also be placed in rooms with different ambient conditions or different air contaminations. It is obvious that the pressure difference can also be adjusted for a maximal admissible contamination, even for a modified blast power.

Preferably an output element over which the incoming of an event such as, for example the exceeding of a pressure difference or the signal of the contact switch, can be output visually and/or acoustically is provided for.

This can also take place in that a pressure difference ascertained by pressure measuring devices is output with a decimal value on a display, whereby for example when a limit for the pressure difference is exceeded, the numerical value begins to flash. It is also possible that a warning light, for example a red luminescent diode, lightens. Furthermore, the warning signal can be given by emitting a signal sound. It is also possible that different contamination degrees of the filter mat and correspondingly different values of the pressure difference are assigned to different colour light signals. For example, for a clean uncontaminated filter mat and a correspondingly light pressure difference, a green luminescent diode can be activated, in case of increasing contamination a yellow luminescent diode and when exceeding an admissible limit for the contamination and a correspondingly high pressure difference a red luminescent diode.

Due to the arrangement of the control element on the inner wall of the basic casing of the device, it is guaranteed that the clear passage section does not have to be reduced. The control element preferably consists of electronic components which, according to our opinion, are already cheap to be bought on the market.

In order to obtain a simple current supply of the control element and of the further components of the device according to the invention, connecting elements are provided for making available the current supply. The same is also valid for connections for emitting a signal, for example to an external place such as a PC or the like.

Embodiments of the invention are represented in the drawings.

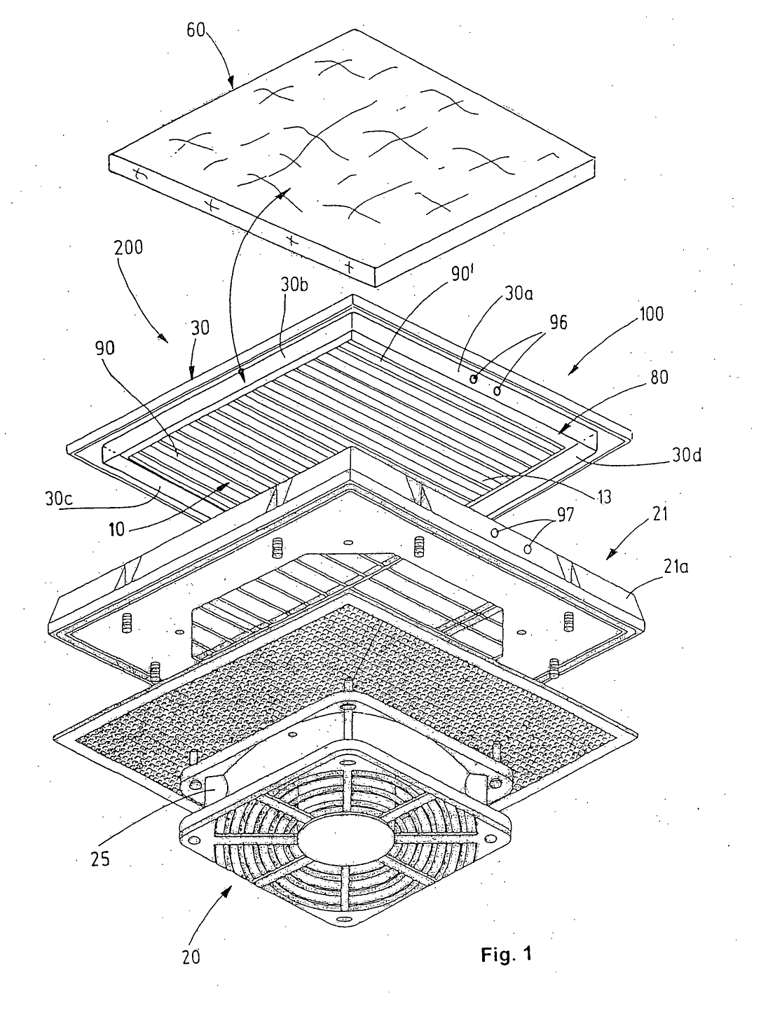

FIG. 1 shows a graphical exploded view of the device for the passage of air consisting of a front design cover with a fan grid and with a filter mat, a basic casing for the design cover and for a fan.

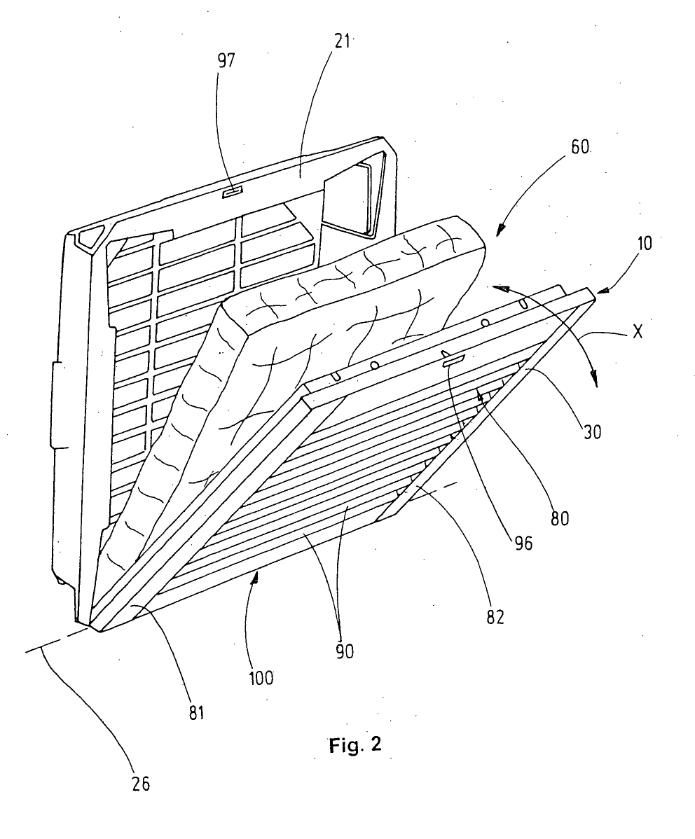

FIG. 2 shows a graphical view of the basic casing with swung open design cover and with a filter mat situated between the basic casing and the design cover.

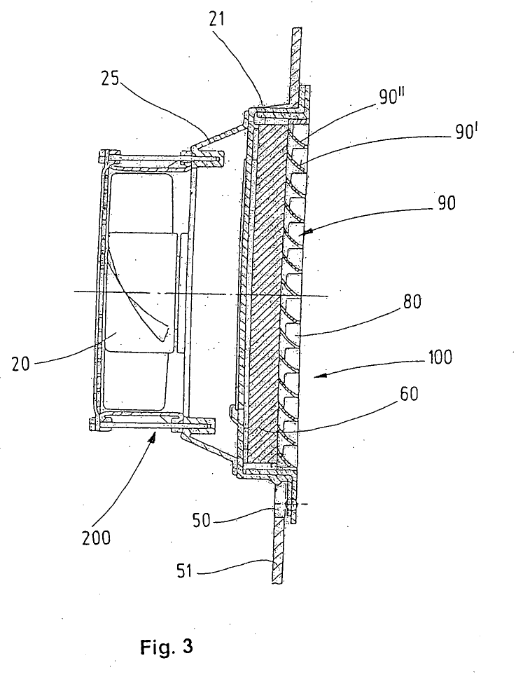

FIG. 3 shows a vertical cross section through the device for the passage of air.

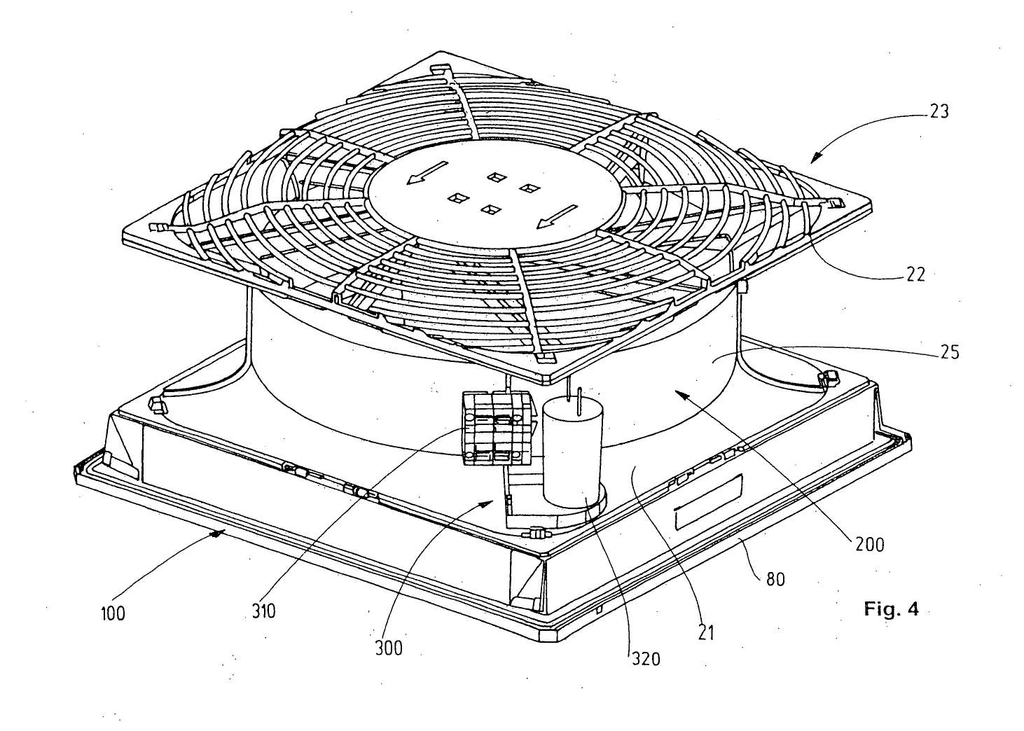

FIG. 4 shows a first spatial view of the device for passage of air.

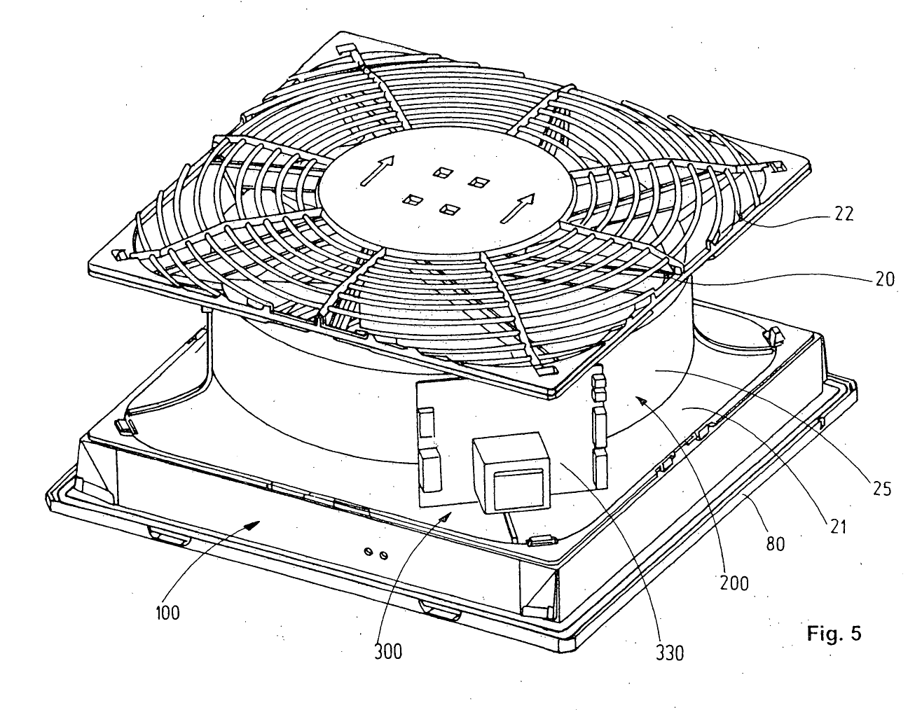

FIG. 5 shows a second spatial view of the device for passage of air.

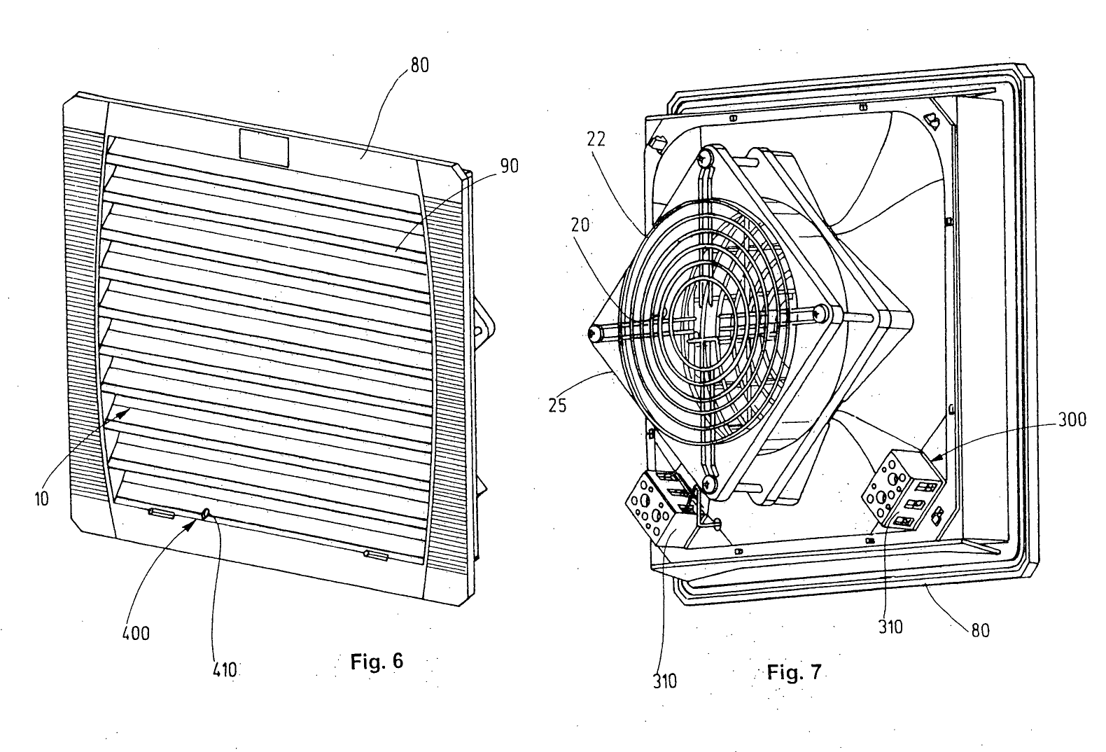

FIG. 6 shows a top view of a cover element of the device for passage of air.

FIG. 7 shows a further spatial view of a further device for the passage of air.

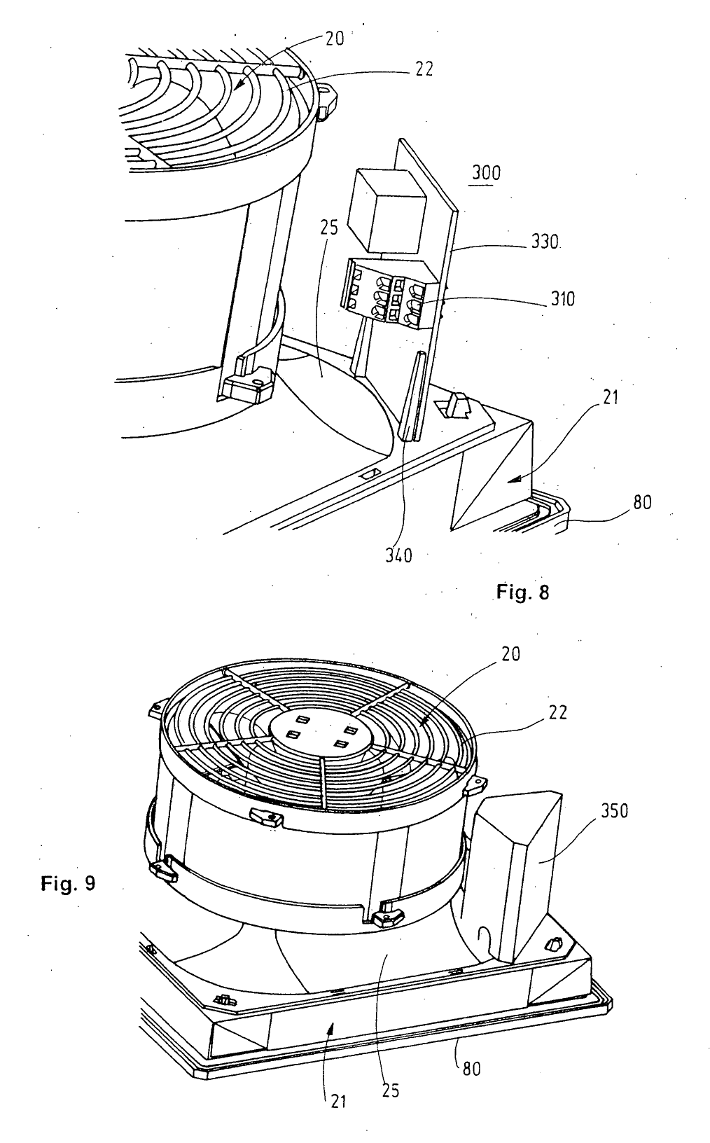

FIG. 8 shows a section of a further spatial view of the device for the passage of air.

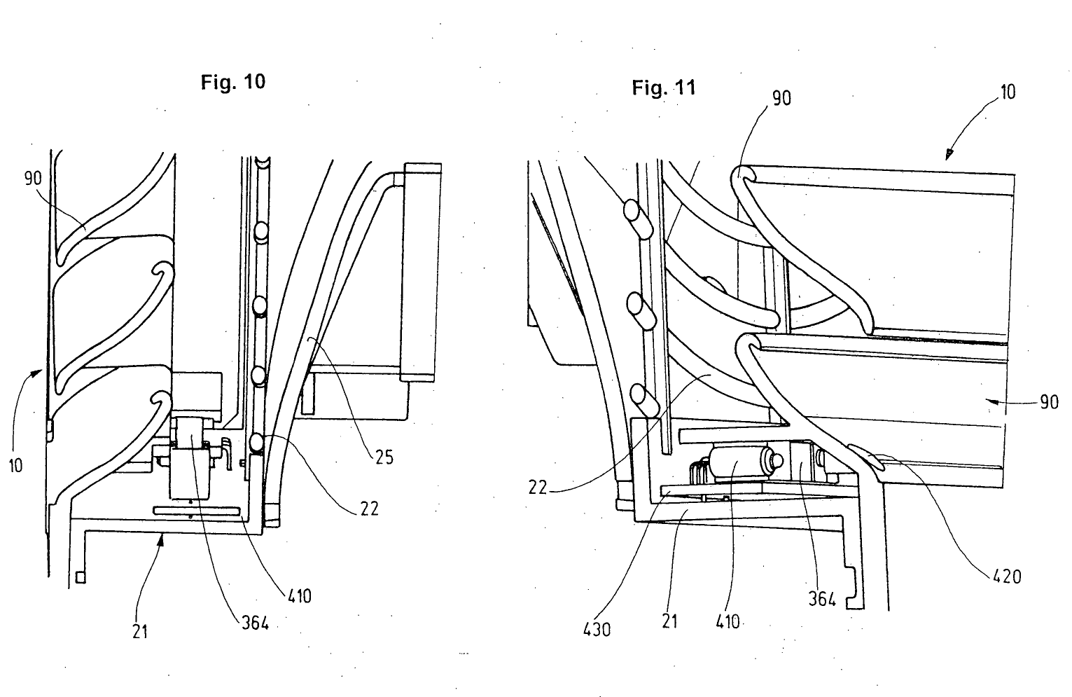

FIG. 9 shows a further view of FIG. 8.

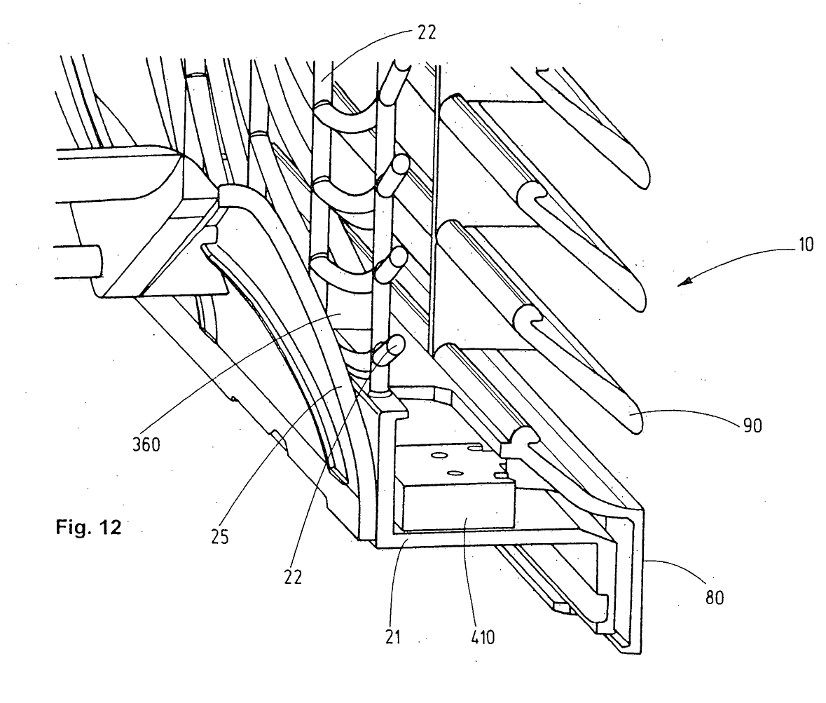

FIG. 10 shows an enlarged cut sectional view of the device for the passage of air.

FIG. 11 shows a further enlarged cut sectional view of the device for the passage of air.

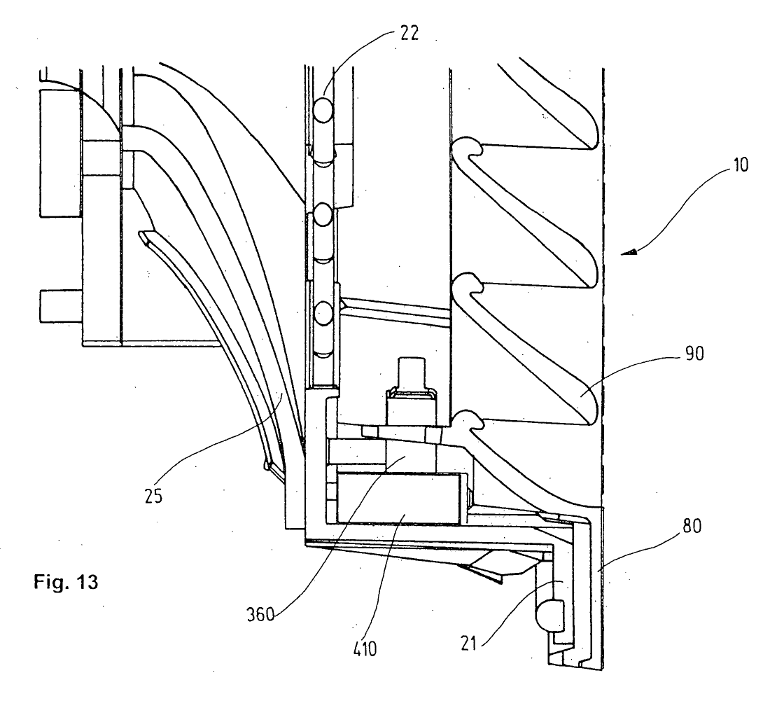

FIG. 12 shows a further enlarged cut sectional view of the device for the passage of air of FIG. 10.

FIG. 13 shows a further enlarged cut sectional view of the device for the passage of air of FIG. 11.

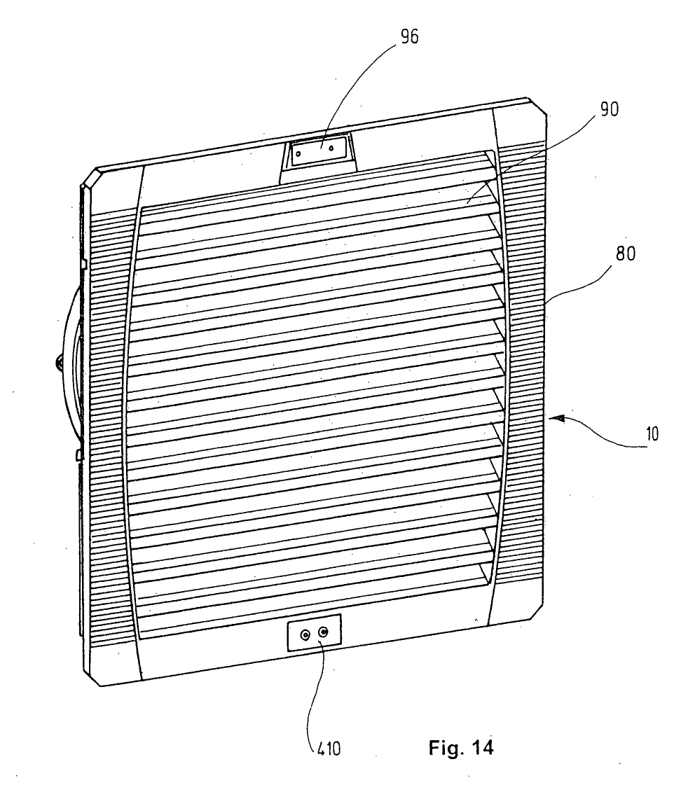

FIG. 14 shows a top view of an alternative cover element of the device for the passage of air.

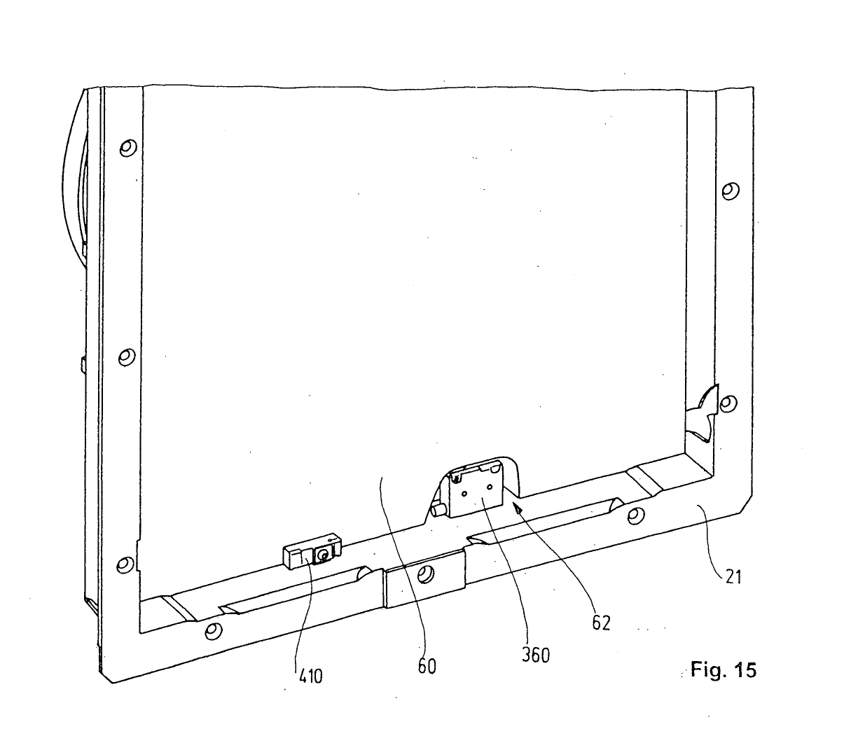

FIG. 15 shows a rear view of a cover element with an inserted filter mat.

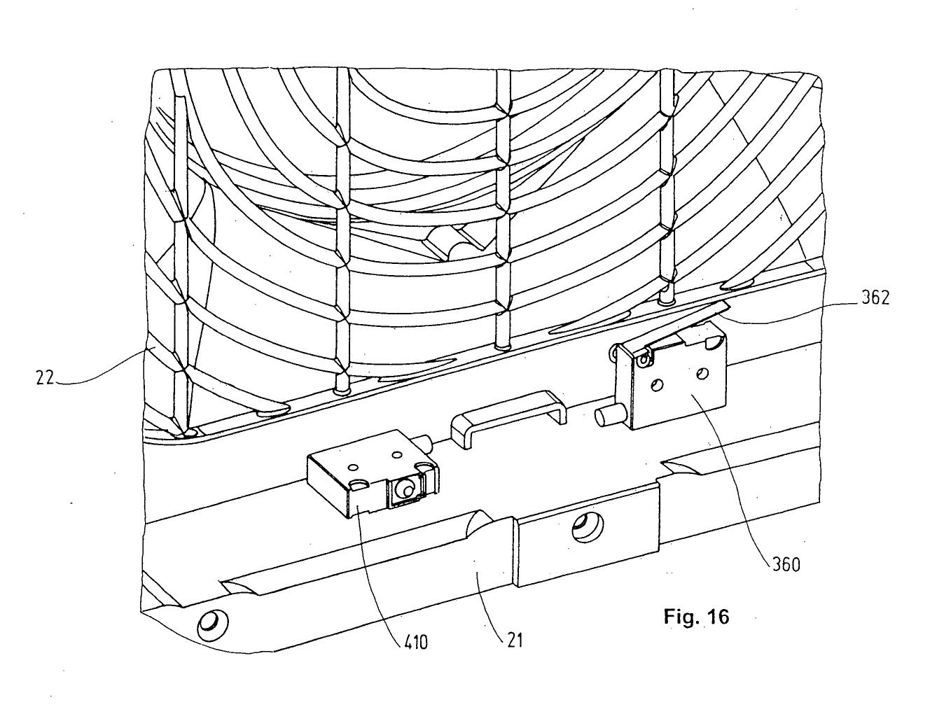

FIG. 16 shows an enlarged sectional view of the cover element according to FIG. 15 without filter mat.

FIG. 1 to 3 show a basic structure of a device for the passage of air 200 without the use of a control device according to the invention. FIG. 1 shows an exploded view thereof. This being, the device for the passage of air 200 can be used in connection with a blast or fan as filter fan and without a blast 20 as outlet filter. The device for the passage of air 200 is used for casings of waste heat producing components such as switch cupboards, electronic cupboards, computer systems or the like, whereby the device for the passage of air 200 is mounted in mounting openings 50 in a wall 51 of such a casing (FIG. 3).

The essential components of the device for the passage of air 200 are a design cover 80 with a fan grid 10 with aeration slits which constitutes the front cover device 100 for a basic casing 21, a blast support 25 for the blast 20 when the device for the passage of air 200 is used as a filter fan (FIG. 1 to 3). The blast 20 is covered with blast grids 22.

The covering device 100 which constitutes the fan grid 10 is configured as a design cover 80 and consists of a frame-type casing 30, preferably with side walls 30a, 30b, 30c, 30d and with lamellar elements 90, whereby aeration slits are configured between the sectionwise overlapping lamellar elements 90. The filter mat 60 can be maintained on the inner wall face of the fan grid 10 in the design cover 80 (FIG. 3) or it is inserted into the basic casing 21 which is closed by means of the design cover 80. The lamellar elements 90 are moulded in two opposed side walls 30b, 30d of the frame-type casing 30 of the design cover 80 or on these side walls. The covering device 100 with the fan grid 10 consists of the frame-type casing 30 which receives the filter mat 60, of a fan grid 10 which is held fixed, removable or swivellable in the casing 30 and which covers the filter mat 60, this grid constituting the design cover 80. This fan grid 10 comprises at least two lateral side walls 30b, 30d which extend on the edges in a longitudinal direction, which are preferably configured as cheeks, between which the lamellar elements 90 are placed.

The design cover 80 which receives the filter mat 60 or the fan grid 10 is swivellable about its bottom-sided swivelling axis 26 in direction of the arrow X to open the receiving chamber for the filter mat between the fan grid 10 and the basic casing 21 (FIG. 2). The locking of the fan grid 10 on the basic casing 21 preferably takes place in the upper area for example by means of a locking device 40, preferably made of the components 96, 97 which are configured as catch cams and snap-in elements (FIG. 2). The actuation of the locking device 40 takes place by means of lamellar elements 90′ over of a lamellar element 90″ of the lamellar elements 90 of the fan grid 10.

FIGS. 4 and 5 show a device for the passage of air according to the invention 200 which is provided with a control device 300 in form of an electronic control consisting of a connecting element 310m a current supply 320, a board 330 which is fixed by means of a support 340 (see FIG. 8) on the basic casing 21. The board 330 comprises electronic components which evaluates signals which are emitted by microswitches 360 (FIG. 10 to FIG. 16) when an event takes place or even continuously (pressure control, not represented).

FIGS. 6 and 14 show embodiments for the design cover 80 which is connected with an output element 400 which is connected with the control device. For the output element 400, the matter is of a colour lamp or of a luminescent diode in one or several colours 410. Depending on the colour or on the fact that the luminescent diode 410 lightens at all, it is indicated if the operation state of the device for the passage of air 200 meets the wished parameters, or if there are differences which require an action of the user. This being, the luminescent diode is placed either offset or central. Two luminescent diodes which indicate then the different states of operation can also be used.

FIG. 11 shows a possible arrangement of the luminescent diode in the area of the design cover 80 or of the fan grid 10. This being, the luminescent diode 410 is placed on a board 430 which is connected with the basic casing 21. This being, the arrangement is such that either the light of the luminescent diode 410 can be projected outwards through an opening 420, or that the luminescent diode 410 penetrates directly into the opening 420.

A microswitch 364 which is connected and switches with the design cover 80 is placed parallel to the luminescent diode 410 in FIGS. 11 and 10. If the design cover 80 is opened, as described above, the microswitch 364 clears and the control device receives a signal on the base of which the luminescent diode 410 is switched after the signal evaluation so that it indicates that the device for the passage of air 200 is not duly closed.

FIG. 7 shows a further embodiment of the device for the passage of air according to the invention 200. This being, two connecting elements 310 are provided which serve on the one hand for the current supply and on the other hand for emitting a signal to the output element 400.

An arrangement of the board 330 on the blast support 25 connected with the basic casing 21 is represented in FIG. 8. The blast support 25 is locked in the basic casing. The board 330 stands vertically to the connecting area of the basic casing 21 and the blast casing 25 in a section of the blast casing 25 which is parallel to the basic casing 21. A connecting element 310 is provided on the board 330. The lines to other components of the control device 300 are not represented. The fixing takes place with a support 340. In FIG. 9, the board 330 with the connecting element 310 is covered with a cover 350.

Besides the microswitch 364, FIGS. 12 and 13 as well as FIGS. 15 and 16 show a further microswitch 360 which guarantees a control if a filter mat 60 is inserted in the device for the passage of air 200. This being, FIG. 15 shows a rear view of the basic casing 21 in which a filter mat 60 is inserted. A recess 62 in the area of which the microswitch 360 is provided is situated in the lower section of the filter mat 60. As it can be seen in FIG. 16, the microswitch 360 comprises a switching mechanism 362 on which the filter mat rests, as can be seen in FIG. 15 so that a signal is transmitted to the control device 300 from which the information is sent that a filter mat is inserted and then a corresponding signal is sent to the output unit for being displayed.

1. Device for the passage of air, in particular filter fan or output filter, with a blast (20) or without a blast, for fitting in a mounting opening (50) in a wall (51), in particular of a casing for waste heat producing components, such as a switch cupboard, an electronic cupboard, a computer system or the like, whereby the device for the passage of air (200) comprises a basic casing (21) with or without a blast support (25), a covering device (100) configured as a design cover (80) with or without peripheral side walls (30a, 30b, 30c, 30d) moulded on the air outlet side and which can be inserted into the basic casing (21) and with a fan grid (10) which has lamellar elements (90, 90′) held on the opposed side walls (30b, 30d) of the design cover (80) and a filter mat (60) placed between the basic casing (21) and the fan grid (10), wherein a control device is provided for with which the correct state of operation of the device for the passage of air (200) can be ascertained, whereby the control device (300) contains at least one monitoring element (360) and at least one control element (330) for ascertaining the state of operation.

2. Device for the passage of air according to claim 1, wherein the matter is for the monitoring element (360) of a contact switch, preferably of a microswitch.

3. Device for the passage of air according to claim 1, wherein the matter is for the monitoring element of a speed monitoring of the blast (20).

4. Device for the passage of air according to claim 1, wherein the matter is for the monitoring element of at least one, preferably of it least two pressure measuring devices.

5. Device for the passage of air according to claim 3, wherein an output element (410) is provided for, whereby the matter is preferably for the output element (410) of a lamp, particularly preferably of a luminescent diode.

6. Device for the passage of air according to claim 1, wherein the control element (330) is placed on the inner wall of the basic casing (21).

7. Device for the passage of air according to claim 1, wherein at least one connecting element (320) is provided for, whereby the matter is preferably of a connecting element for a current supply and/or of a connecting element for a signal transmission.

8. Device for the passage of air according to claim 1, wherein the control element (330) has at least one electronic component.
